(19) United States
(12) Patent Application Publication
(10) Pub. No.: US 2008/0255869 A1
(43) Pub. Date: Oct. 16, 2008

(54) Generating safety report for fleet of vehicles

(76) Inventors: Ayden F. Young, Gilbert, AZ (US); James C. Reynolds, San Jose, CA (US)

Correspondence Address: TANKHILEVICH, BORIS;Law Offices Of Boris G. Tankhilevich, Suite A, 536 North Civic Drive, Walnut Creek, CA, 94597, US

(21) Appl. No.: 12/082,487

(22) Filed: Apr. 12, 2008

Related U.S. Application Data
(62) Division of application No. 10/770,998, filed on Feb. 2, 2004.

(51) Int. Cl. G06Q 99/00

(52) U.S. Cl. 705/1

(57) ABSTRACT

A method of generating a safety report for a fleet of vehicles comprising: (A) collecting a raw acceleration data for an each maneuver for each vehicle by using a firmware in a vehicle-based mobile unit, wherein the vehicle-based mobile unit comprises a computer processor, and a navigation system including a navigation receiver; (B) processing the collected raw acceleration data; and (C) transmitting the collected processed acceleration data to a database.

This is a divisional application for the U.S. patent application Ser. No. 10/770,998, filed on Feb. 2, 2004, and entitled: “DRIVER PERFORMANCE STATISTICS COLLECTION METHOD AND APPARATUS”.

### BACKGROUND OF THE INVENTION

1. Field of the Invention

The present invention is in the field of collecting data, performing statistical analysis on the data and reporting the results of the statistical analysis. More specifically, the present invention relates to driver performance statistics collection method and apparatus.

2. Discussion of the Prior Art

Driver safety and truck rollovers are inherent issues in the ready-mixed concrete industry. Concrete producers and truck drivers have critical concerns and responsibilities regarding profits, equipment operating costs, and safety. In addition to the lost productivity that results from an accident, there are high direct repair and potential liability costs. Other cost factors attributable to the unsafe driving behaviors that can lead to accidents are higher insurance rates, and higher fuel, tire and maintenance costs.

The same problems exist in other industries, for example, in the industries related to transportation of different types of liquids. Some states have specific regulations directed to improve safety of transportation of flammable liquids. For example, the state of Michigan has some unique requirements for flammable liquids and gases when transported in bulk. Due to Michigan's weight law, which has no gross weight limit, some restrictions have been placed on the size of tanks used to transport flammable liquids and gases. These provisions can be found in MCLA § 257.722a of the Michigan Vehicle Code.

What is needed is a method and an apparatus that would allow early detection of unsafe driving habits which would help fleet industries to decrease the insurance rates, decrease fuel consumption, reduce tire and maintenance costs, and better comply with state regulations and codes.

### SUMMARY OF THE INVENTION

To address the shortcomings of the available art, the present invention provides a method and apparatus for evaluating driving habits of different drivers by generating various safety reports.

One aspect of the method of the present invention is directed to a method of generating a safety report for a fleet of vehicles.

In one embodiment of the present invention, the vehicle-based mobile unit comprises a computer processor, and a navigation system including a navigation receiver, and a method of generating a safety report for a fleet of vehicles comprises: (A) collecting a raw acceleration data for each maneuver for each vehicle by using a firmware in a vehicle-based mobile unit; (B) processing the collected raw acceleration data; and (C) transmitting the collected processed acceleration data to a database.

In one embodiment of the present invention, the step (A) further comprises: (A1) collecting the raw acceleration data for each maneuver for each vehicle by using the firmware in the vehicle-based mobile unit; wherein each maneuver is selected from the group consisting of: {a right turn when the vehicle is loaded; a left turn when the vehicle is loaded; a start when the vehicle is loaded; a stop when the vehicle is loaded; a turn when the vehicle is unloaded; a start when the vehicle is unloaded; and a stop when the vehicle is unloaded}.

In one embodiment of the present invention, the step (A) further comprises: (A2) collecting the raw acceleration data for each maneuver for each vehicle by using the firmware in the vehicle-based mobile unit; wherein each maneuver is selected from the group consisting of: {a turn; a start; and a stop}.

In one embodiment of the present invention, the step (B) further comprises: (B1) reserving a set of data “bins” for each set of acceleration data collected for one maneuver; wherein each bin includes a count of the occurrences of an acceleration value in a particular range; (B2) calculating a maximum raw acceleration value for each particular range of acceleration values for the maneuver; (B3) incrementing a count in the bin in which the calculated maximum acceleration value falls for the maneuver; and (B4) repeating the steps (B1-B3) for each maneuver.

In one embodiment of the present invention, the step (B) further comprises: (B5) inputting a set of bin data for the fleet of vehicles for each maneuver; (B6) applying a bin weighting factor for each bin data; (B7) calculating a mean and a standard deviation for each maneuver for the fleet of vehicles; and (B8) storing the set of the mean and the standard deviation values for each maneuver for the fleet of vehicles.

In one embodiment of the present invention, the step (B) further comprises: (B9) inputting set of bin data for each maneuver; (B10) applying a bin weighting factor for each bin data; (B11) calculating a score for each maneuver for each vehicle; (B12) storing the set of scores for each maneuver for each vehicle in the database; and (B13) generating a report for each maneuver for each vehicle.

In one embodiment of the present invention, the step (B) further comprises: (B14) inputting the set of scores for each maneuver for each vehicle; (B15) applying a maneuver weighting factor; (B16) calculating a set of weighted composite scores for all the maneuvers for each vehicle; (B17) storing the set of weighted composite scores and the set of maneuver weighting factors for each vehicle in the database; and (B18) generating a report including the set of weighted composite scores and the set of maneuver weighting factors for each vehicle.

In one embodiment of the present invention, the step (C) further comprises: (C1) transmitting the report including the set of weighted composite scores and the set of maneuver weighting factors for each vehicle to a Web site by using a wireless modem.

In one embodiment of the present invention, the step (C) further comprises: (C2) transmitting a set of bin data for each maneuver for each vehicle to a Web site for further processing and for generating a safety report.

### BRIEF DESCRIPTION OF DRAWINGS

The aforementioned advantages of the present invention as well as additional advantages thereof will be more clearly understood hereinafter as a result of a detailed description of a preferred embodiment of the invention when taken in conjunction with the following drawings.

FIG. 1 illustrates the flow chart of the method of the present invention for calculating an individual score for each maneuver for each vehicle, and for calculating a weighted composite score for each vehicle.

FIG. 2A depicts a mixer drum truck equipped with an apparatus of the present invention for generating safety reports to vehicle owners and to fleet managers detailing how their drivers operate their vehicles.

FIG. 2B shows the in more detail an apparatus of the present invention for generating safety reports in more details.

FIG. 3 illustrates the Score Configuration button screen on the Report Options screen in the DriveSafe computer program Televisant™ that implements the present invention.

FIG. 4 depicts a DriveSafe Fleet Chart that provides individual weighted composite scores for different vehicles that are identified by different numbers.

FIG. 5 illustrates DriveSafe reports that include individual scores for each driving maneuver, plus a weighted composite score for each vehicle.

FIG. 6 shows how to run a safety report by using a DriveSafe implementation of the present invention.

FIG. 7 illustrates how the raw data is collected by measuring a set of acceleration values for different maneuvers under different vehicle conditions in the following categories {start, stop, right turn, left turn loaded vehicle, and unloaded vehicle}.

FIG. 8 shows the flow chart of the overall processing of bin data to determine a vehicle score.

### DETAILED DESCRIPTION OF THE PREFERRED AND ALTERNATIVE EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents that may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

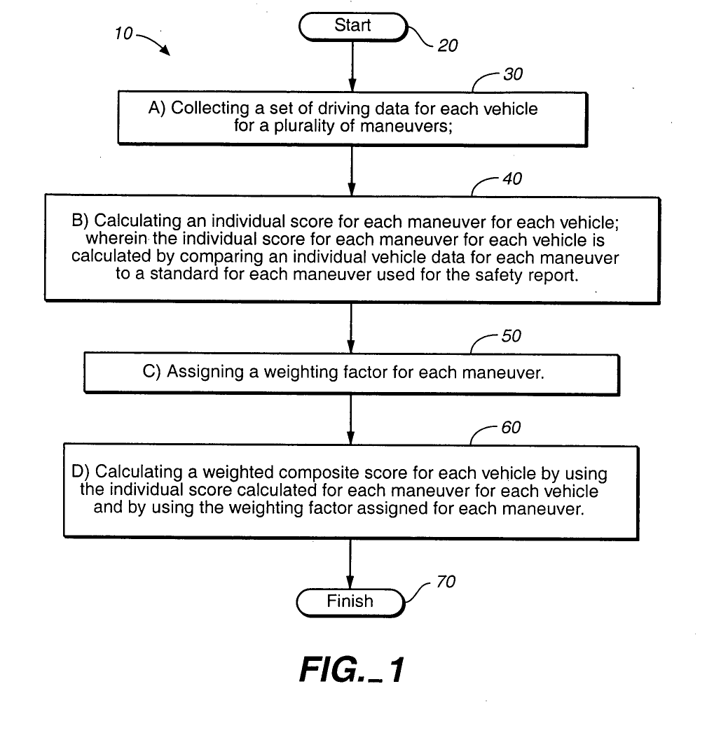

FIG. 1 illustrates the flow chart 10 of the method of the present invention for calculating an individual score for each maneuver for each vehicle, and for calculating a weighted composite score for each vehicle. As shown in the flow chart 10 of FIG. 1, in one embodiment, the method of the present invention comprises: step 30 of collecting a set of driving data for each vehicle for a plurality of maneuvers; and step 40 of calculating an individual score for each maneuver for each vehicle. The individual score for each maneuver for each vehicle is calculated by comparing an individual vehicle data for each maneuver to a standard for each maneuver used for the safety report.

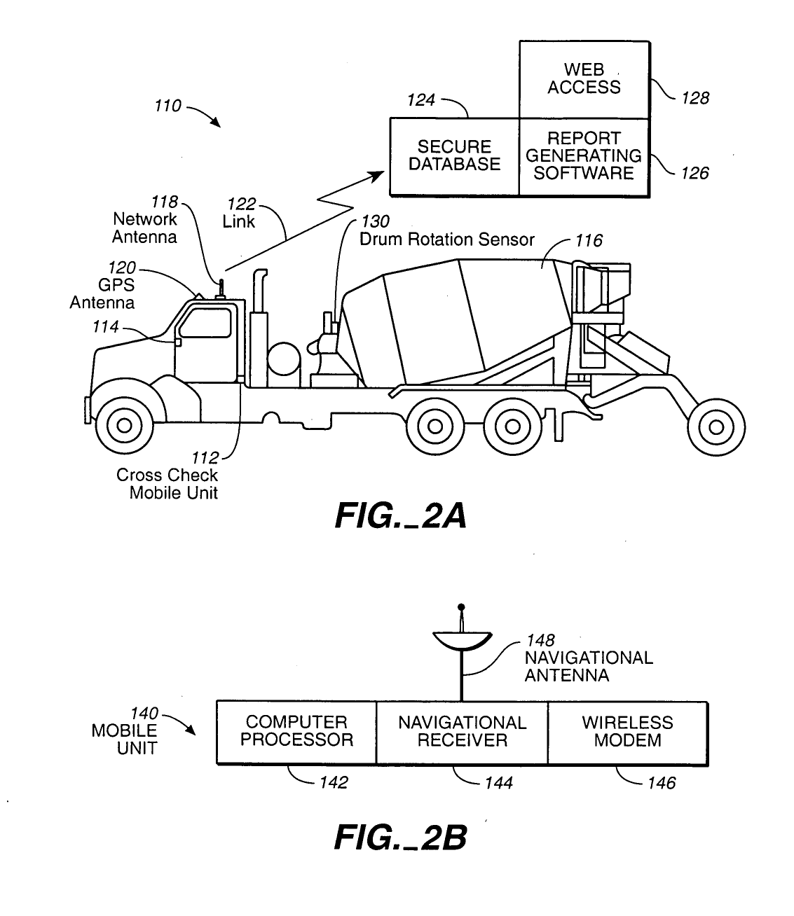

In one embodiment of the present invention, FIG. 2A depicts a mixer drum truck 110 having a drum 116. The mixer drum truck 110 is equipped with a mobile unit 112 including an apparatus of the present invention for generating safety reports to vehicle owners and to fleet managers detailing how their drivers operate their vehicles. The mobile unit 112 communicates with a secure database 124 by using a network antenna 118 and a communication link 122. The block including a report generating software 126 and including a Web access means 128 processes the collected safety data stored in the secure database 124 and generates a safety report that is also accessible via the Web.

In one embodiment, FIG. 2B shows in more detail the apparatus 140 of the present invention for generating safety reports in more details. The apparatus 140 includes: a computer processor 142, a navigation receiver 144 including a navigational antenna 148, a communication means configured to transmit data to the secure database 124 (of FIG. 2A) that is Web-accessible to process the safety data and to generate a safety report. In one embodiment, the communication means comprises a wireless modem 146.

In one embodiment of the present invention, when the vehicle is a mixer drum truck 110 including a rotating drum 116, as shown in FIG. 2A, the drum speed sensor 130 (of FIG. 2A) is configured to measure a mixer drum speed to determine the change in the Center of Gravity (CG) of the vehicle. In one embodiment of the present invention, the mixer drum truck 110 can perform each of the following maneuvers that are evaluated in the safety report: {a right turn when the vehicle is loaded; a left turn when the vehicle is loaded; a start when the vehicle is loaded; a stop when the vehicle is loaded; a turn when the vehicle is unloaded; a start when the vehicle is unloaded; and a stop when the vehicle is unloaded}. In this embodiment of the present invention, the left and right turns, and the loaded and unloaded trips are assigned different weighting factors.

Indeed, the distinguishing of driver performance between right and left turns is relevant if the vehicle has a center of gravity that is offset from the centerline of the vehicle. In the case of a ready mixed mixer drum truck, the concrete mix is displaced to the driver's side of the vehicle as the drum turns. As the drum turns faster, more of the mix is moved to the driver's side and higher from the ground than it is when the drum is stopped. This makes right hand turns more dangerous. As a result, the separation of vehicle accelerations into separate bins for left and right turns is important. In addition, the speed of the drum is also taken into account because the degree of offset of the center of gravity increases with drum speed.

Referring still to FIG. 1, in one embodiment of the present invention, when the vehicle is a mixer drum truck 110 including a rotating drum 116, as shown in FIG. 2A, the step 30 of collecting the set of driving data for each vehicle for the plurality of maneuvers performed by this vehicle further includes the step of collecting the set of driving data for each vehicle for the plurality of maneuvers. In this embodiment of the present invention, as was stated above, the right turns and left turns, as well as loaded and unloaded trips are separated into different categories, that is each maneuver is selected from the group consisting of: {a right turn when the vehicle is loaded; a left turn when the vehicle is loaded; a start when the vehicle is loaded; a stop when the vehicle is loaded; a turn when the vehicle is unloaded; a start when the vehicle is unloaded; and a stop when the vehicle is unloaded}.

In general, any vehicle loaded with an asymmetric load (not shown) in such a way that its Center of Gravity (CG) is offset from the centerline of the vehicle, is subject to the weighting factors assignment based on differentiating between right and left turns and loaded and unloaded trips. A plurality of individual weight sensors (not shown) could detect loading differences between the right and left sides of such asymmetrically loaded vehicle that can be used to assign the weighting factors.

More specifically, in one embodiment of the present invention, the load in a liquid tanker truck (not shown) may shift significantly to the right or left during a turn, and depending on the baffle arrangement in the tank, the dynamic sloshing motion of the liquid and the loading of the vehicle, those shifts may be different between right and left turns. If this is the case, a plurality of liquid level sensors inside the tank (not shown) may be used to determine the degree of shift of the load and contribute to the driver performance scoring in much the same way as does drum speed in a ready mix truck.

Referring still to FIG. 1, in one embodiment of the present invention, the step 30 of collecting the set of driving data for each vehicle for the plurality of maneuvers (of FIG. 1) further includes the step of collecting the set of driving data for each vehicle for the plurality of maneuvers, wherein each maneuver is selected from the group consisting of: {a turn when the vehicle is loaded; a start when the vehicle is loaded; a stop when the vehicle is loaded; a turn when the vehicle is unloaded; a start when the vehicle is unloaded; and a stop when the vehicle is unloaded}. In this embodiment, there is no difference between left and right maneuvers. Indeed, in some instances, vehicles are loaded symmetrically and there is no need to distinguish between left and right turns. For example, a dump truck hauling sand or gravel is loaded with material that tends to be evenly distributed by gravity within the dump bed.

Referring still to FIG. 1, in one embodiment of the present invention, the step 30 of collecting the set of driving data for each vehicle for the plurality of maneuvers (of FIG. 1) further includes the step of collecting the set of driving data for each vehicle for the plurality of maneuvers, wherein each maneuver is selected from the group consisting of: {a turn; a start; and a stop}. In this embodiment, there is no difference between left and right, and between loaded and unloaded trips. Indeed, in some instances, the driver performance measurement is deployed on vehicles where there is no difference in the vehicle's weight between loaded and unloaded conditions. In such cases, maneuver statistics are collected on the vehicle but are not separated into loaded and unloaded bins (please, see discussion below). For example, data may be collected on a standard automobile. There is no appreciable difference in the weight of vehicle and driver during the day and therefore no need to distinguish between loaded and unloaded conditions. The reports would include a single set of maneuver scores plus a composite score rather than a loaded set and an unloaded set plus the composite.

Referring still to FIG. 1, in one embodiment of the present invention, the step 30 of collecting the set of driving data for each vehicle for the plurality of maneuvers further includes the step of obtaining a set of positioning data including a set of acceleration data and a set of speed data for each vehicle for each maneuver. The speed data is an average vehicle speed while operating.

In one embodiment of the present invention, the step of obtaining the set of positioning data including the set of acceleration data and the set of speed data for each vehicle for each maneuver further includes the step of obtaining the set of positioning data including the set of acceleration data and the set of speed data for each vehicle for each maneuver by using a navigation system selected from the group consisting of: {GPS; GLONASS; combined GPS/GLONASS; GALILEO; pseudolite-based navigation system; and inertial navigation system (INS)}.

A Satellite Positioning System (SATPS), such as the Global Positioning System (GPS), or the Global Orbiting Navigation Satellite System (GLONASS), or the combined GPS-GLONASS, (or the future GALILEO), uses transmission of coded radio signals, from a plurality of Earth-orbiting satellites. An SATPS antenna receives SATPS signals from a plurality (preferably four or more) of SATPS satellites and passes these signals to an SATPS signal receiver/processor, which (1) identifies the SATPS satellite source for each SATPS signal, (2) determines the time at which each identified SATPS signal arrives at the antenna, and (3) determines the present location of the SATPS satellites. The range (rᵢ) between the location of the i-th SATPS satellite and the SATPS receiver is equal to the speed of light c times (tᵢ), wherein (tᵢ) is the time difference between the SATPS receiver's clock and the time indicated by the satellite when it transmitted the relevant phase. However, the SATPS receiver has an inexpensive quartz clock which is not synchronized with respect to the much more stable and precise atomic clocks carried on board the satellites. Consequently, the SATPS receiver estimates a pseudo-range (prᵢ) (not a true range) to each satellite. After the SATPS receiver determines the coordinates of the i-th SATPS satellite by demodulating the transmitted ephemeris parameters, the SATPS receiver can obtain the solution of the set of the simultaneous equations for its unknown coordinates (x₀, y₀, z₀) and for unknown time bias error (cb). The SATPS receiver can also determine velocity of a moving platform.

Pseudolites are ground-based transmitters that can be configured to emit GPS-like signals for enhancing the GPS by providing increased accuracy, integrity, and availability. Accuracy improvement can occur because of better local geometry, as measured by a lower vertical dilution of precision (VDOP). Availability is increased because a pseudolite provides an additional ranging source to augment the GPS constellation.

Recent advances in Inertial Navigation Systems (INS) technologies make it feasible to build a very small, low power INS system. Acceleron Technology, Inc., located in San Francisco, Calif., has built small light weight Inertial Navigation System (INS) using three accelerometers to measure three components of the local acceleration vector, three magnetometers to measure three components of the local gravitational vector, plus some software. An accelerometer is a sensor that measures acceleration, speed and the distance by mathematically determining acceleration over time. A magnetometer is a device that measures a local magnetic field. The local gravitational factor can be calculated by using the measured local magnetic field, because the local gravitational field, as well as the local magnetic field, are both defined by the local Earth geometry, as well explained in the book “Applied Mathematics in Integrated Navigation Systems”, published by American Institute of Aeronautics and Astronautics, Inc, 2000, by Robert M. Rogers. The “Applied Mathematics in Integrated Navigation Systems” teaches how geometrical shape and gravitational models for representing the Earth are used to provide relationship between ECEF position x-y-z components and local-level latitude, longitude, and attitude positions. The “Applied Mathematics in Integrated Navigation Systems” also teaches how a vehicle's position change in geographical coordinates is related to the local Earth relative velocity and Earth curvature.

Referring still to FIG. 2A, the present disclosure focuses on the Televisant® DriveSafe product developed by Trimble that includes a GPS navigation system including a GPS antenna 120, though any other disclosed above navigation system could be used for the purposes of the present invention. In the present invention, one does not use positions. The fact that velocities are part of a standard GPS data set is the only connection between “positioning data” and the velocities.

Referring still to FIG. 1, in one embodiment of the present invention, wherein the vehicle is a mixer drum truck (110 of FIG. 2A) equipped with a drum speed sensor 130 of FIG. 2A), the step 30 of collecting the set of driving data for each vehicle for the plurality of maneuvers further includes the step of measuring a mixer drum speed by using the drum speed sensor (130 of FIG. 2A) to determine the change in the Center of Gravity (CG) of the vehicle.

In one embodiment of the present invention, wherein the vehicle is a tank truck used for transport of liquids (not shown), the step 30 of collecting the set of driving data for each vehicle for the plurality of maneuvers further includes the step of measuring a dynamic level of liquid in the tank truck by using a plurality of liquid level sensors (not shown) to determine the change in the Center of Gravity (CG) of the vehicle.

Referring still to FIG. 1, in one embodiment of the present invention, the step 40 of calculating the individual score for each maneuver for each vehicle further includes the step of comparing the set of acceleration data for each vehicle for each maneuver to a standard for each maneuver for a customer's fleet. In this embodiment of the present invention, the step of comparing the set of acceleration data for each vehicle for each maneuver to the standard for each maneuver for the customer's fleet further comprises the step of calculating a mean and a standard deviation for a set of acceleration data for each maneuver for the customer's fleet as the standard for each maneuver for the customer's fleet.

In one embodiment of the present invention, the step 40 of calculating the individual score for each maneuver for each vehicle further includes the step of comparing the set of acceleration data for each vehicle for each maneuver to a standard for each maneuver for an industry as a whole. In this embodiment of the present invention, the step of comparing the set of acceleration data for each vehicle for each maneuver to the standard for each maneuver for the industry as a whole further comprises the step of inputting a mean and a standard deviation for a set of acceleration data for each maneuver used as the standard for the industry as a whole.

Vehicle scores are calculated by comparing the vehicle data to the standard used for the report. The selection of the performance standard for the fleet or for the industry as a whole is made when the report is run. More specifically, if the vehicle's acceleration data matches the standard's average, the score is arbitrarily set to 100. One standard deviation in the standard's data is assigned the value of 10 points, so if the vehicle's acceleration is higher than the standard's average by one standard deviation, the score is 110. For data two standard deviations below the average standard, the score is 80. The data are assumed to follow a statistical “normal distribution”, so 98% of all scores will be between 70 and 130.

In one embodiment, the Televisant® DriveSafe product developed by Trimble measures the accelerations (commonly called G-forces) exerted on the truck during various driving maneuvers (turns, starts, stops, etc.) and compares these measurements to the average for the customer's fleet or to the industry as a whole. Scores are calculated for several categories of maneuvers and the individual scores plus a composite Driver Score is reported. Mixer drum speed (if the truck is equipped with a drum-speed sensors) and vehicle speed are also considered. The driver's performance can be compared against the rest of the drivers in the fleet and against the industry average.

Referring still to FIG. 1, in one embodiment, the method of the present invention further comprises: step 50 of assigning a weighting factor for each maneuver; and step 60 of calculating a weighted composite score for each vehicle by using the individual score calculated for each maneuver for each vehicle and by using the weighting factor assigned for each maneuver.

In one embodiment of the present invention, the step 50 of assigning the weighting factor for each maneuver further includes the step of assigning a predetermined weighting factor for each maneuver. For instance, developed by Trimble “the Overall Score” is a weighted average of the individual maneuver scores. The default values were judged by people in the industry to be a good set of weights for overall driver safety in a ready mixed mixer drum truck. These values can be changed based on the operations manager's judgment or because of special local conditions. A different set of weights may be chosen to extend the analysis for other purposes. A set that emphasizes tire wear might more heavily weight stops and turns, where a fuel-oriented report might have higher weights on starts and speed.

Referring still to FIG. 1, in one embodiment of the present invention, the step 50 of assigning the weighting factor for each maneuver further includes the step of calculating the weighting factor for each maneuver.

In one embodiment of the present invention, wherein the vehicle is the mixer drum truck (110 of FIG. 2A) equipped with the drum speed sensor (130 of FIG. 2B), and the step 50 of assigning the weighting factor for each right turn maneuver further includes the step of calculating the weighting factor for each right turn maneuver based on the mixer drum speed measured by the drum speed sensor for each maneuver.

In one embodiment of the present invention, wherein the vehicle is the tank truck used for transport of liquids (not shown), the step 50 of assigning the weighting factor for each maneuver further includes the step of calculating the weighting factor for each maneuver based on the dynamic level of liquid in the tank truck measured by the plurality of liquid level sensors (not shown) for each maneuver.

In one embodiment, the present invention is implemented by Trimble Limited, located in Sunnyvale, Calif., by using a DriveSafe program. The DriveSafe program provides a window visibility into individual driver behavior beyond just driving speed by providing indicators of other, less-noticeable forms of aggressive driving. This is done by using Scorecards.

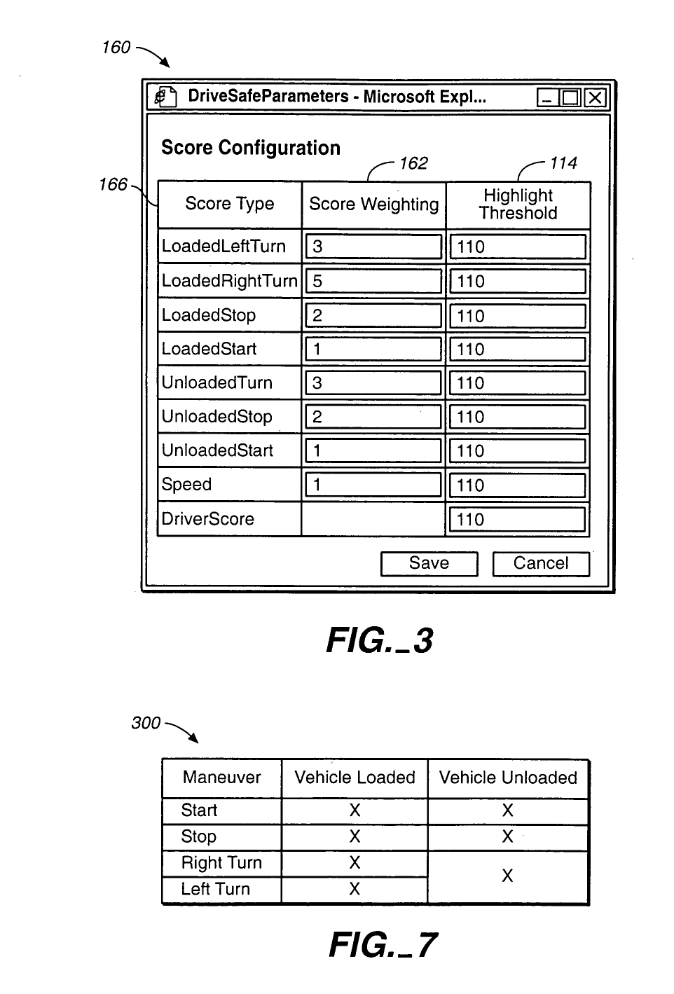

More specifically, FIG. 3 illustrates the Score Configuration button 160 on the Report Options screen in the DriveSafe computer program Televisant™ that implements the present invention. There are two configuration items that can be set using the Score Configuration button 160 on the Report Options screen. The first is the Score Weighting value 162. This defines the contribution of each of the maneuver types to the composite driver score. If, for example, a loaded right turns are considered to be five times as important as unloaded starts, the Loaded Right Turn value should be set to 5 and the Unloaded Start value to 1. The weights can be set to any value, including zero, and do not need to add up to any particular sum. Since changing these values can change the relative positions of different vehicles, the weights used are printed on the report itself. It is expected that once a set of weights is defined, it should not be changed arbitrarily. However, a different set of weights can be used for different purposes. A report that is intended for driver safety may have one set of weights; a different set might be defined if a more equipment-oriented report that places a higher weight on those maneuvers that cause excessive tire wear or engine over-revving is desired.

Referring still to FIG. 3, the second configuration item is the Highlight Threshold 164. Scores that are greater than or equal to these settings are highlighted in yellow on the reports and appear in red on the charts.

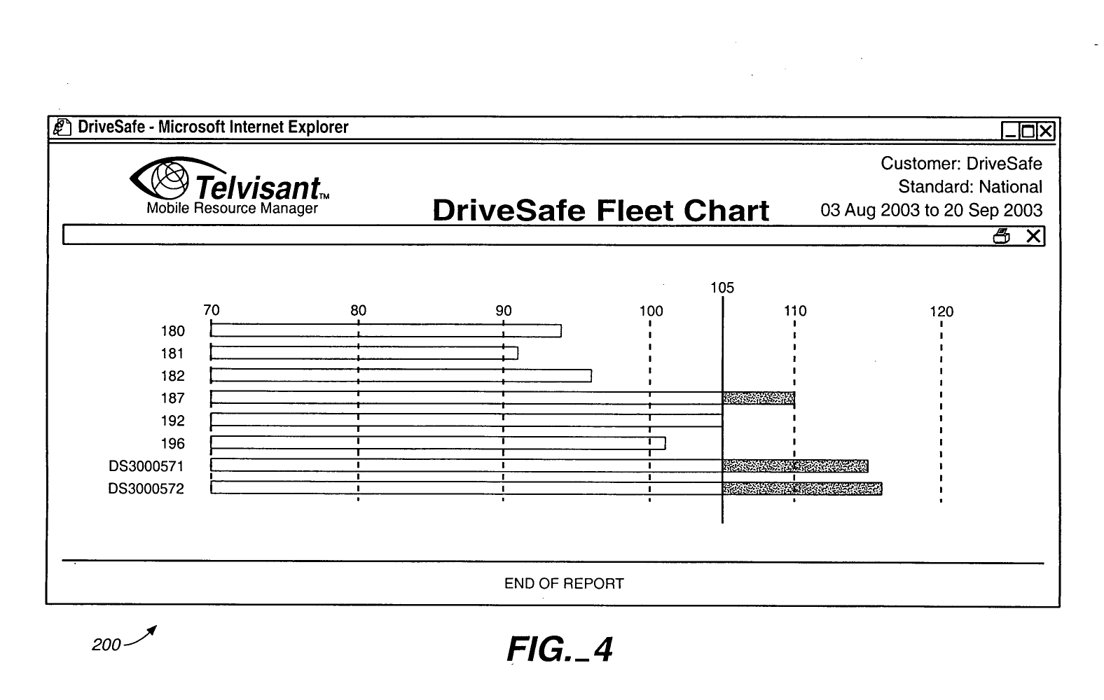

FIG. 4 illustrates a DriveSafe Fleet Chart 200 that provides individual scores for different vehicles that are identified by the following numbers: {180, 181, 1282, 187, 192, 195, DS 3000571 and DS3000572}. Supervisors can use this tool to conduct specifically targeted driver training and counseling programs. Indeed, from DriveSafe Fleet Chart 200 one can see that vehicles DS 3000571 and DS3000572 have the safety scores far worse than the national standard chosen for this particular report. On the other hand, the vehicles 180, 181, 182 have the safety scores far better than the national averages.

In many cases, otherwise good drivers simply need to be reminded about certain elements of their driving behavior, such as better preparing to stop when the truck is loaded. In other cases, drivers need to be trained to significantly alter their driving style when the truck is loaded in order to avoid potential rollover situations. The driver scores are accumulated over a long period of time, allowing visibility into trends in driving behavior.

DriveSafe is not a direct, near-accident-event indicator. The Scorecard is intended to assist in training and monitoring and should not be used to unfairly penalize a driver for one or two hard maneuvers that may have been necessary due to poor driving of others on the road. For this reason the reports should always be run using a one-week or longer reporting period.

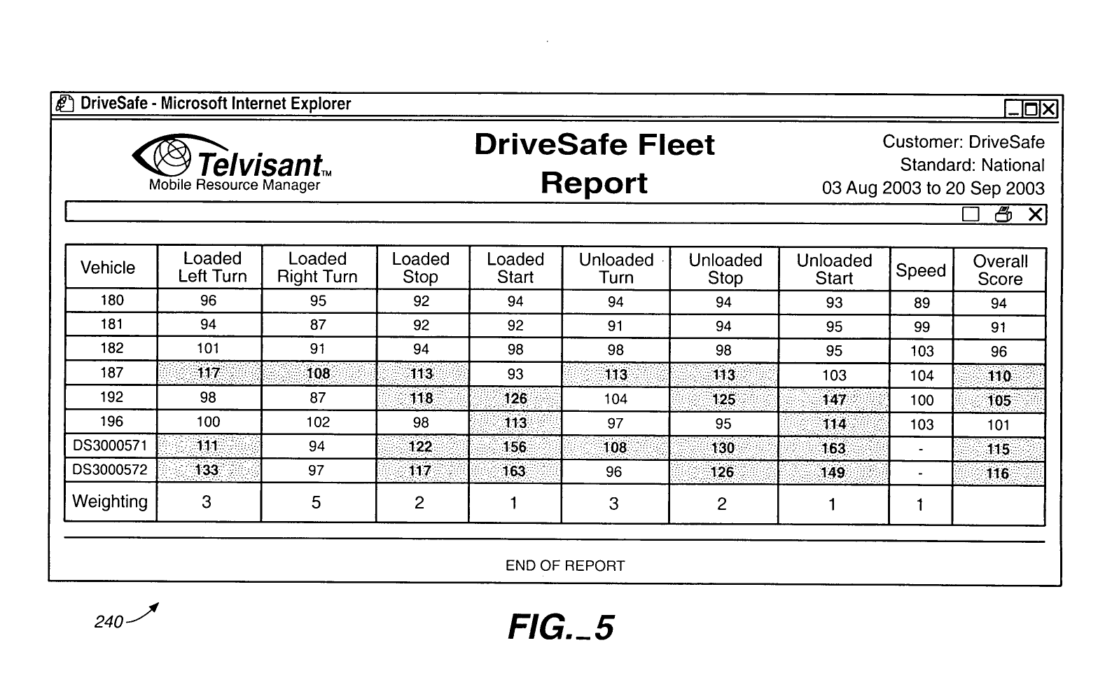

DriveSafe reports include individual scores for each driving maneuver, plus a weighted composite score for the vehicle, as shown in FIG. 5. These data can be presented and printed in a tabular Fleet Report and an easy-to-read Fleet Chart. The data can also be exported in a format compatible with standard data analysis tools such as Microsoft Excel.

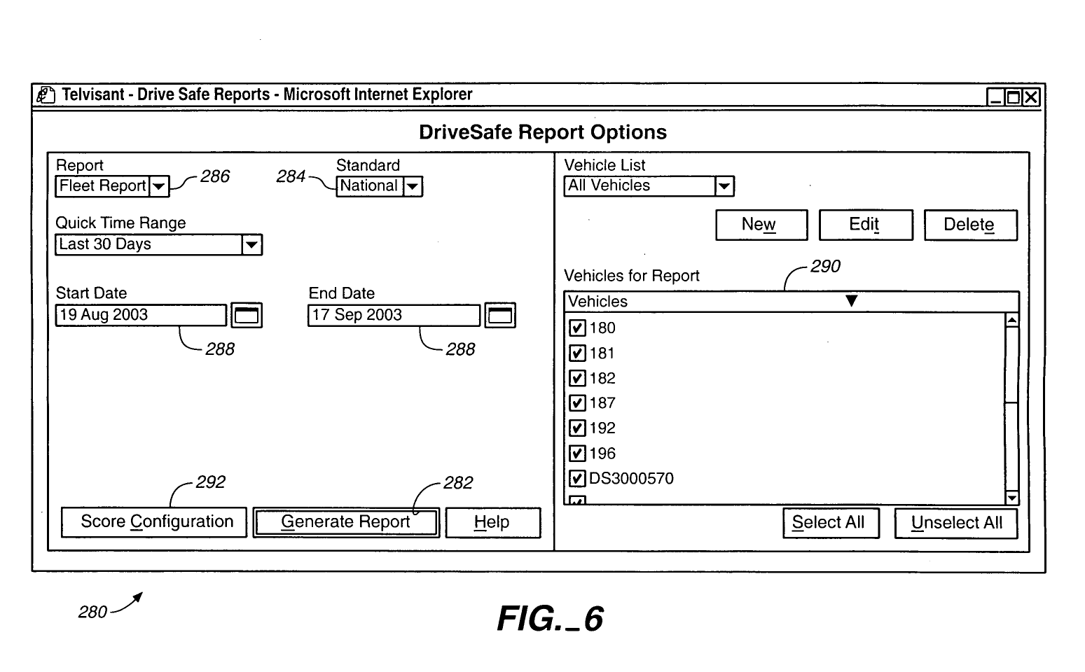

FIG. 6 shows how to run a safety report by using a DriveSafe implementation of the present invention. Several settings should be made before running a report. For instance, the report type can be a Fleet Report or a Fleet Chart (button 286); the standard against which the vehicles are scored could be chosen as a Fleet Standard, or as a National Standard (button 284); the date range over which the report is run (buttons 288); the vehicles to be included in the report (button 290). The report or chart is displayed on the screen after pressing clicking the Generate Report button 282. The report can then be printed using the printer icon, or exported to an Excel worksheet a file on the local computer using the disk icon. The Score Configuration button can be used to choose the Score weighting value, or a Highlight Threshold (Please, see the discussion of FIG. 3 above).

In one embodiment of the present invention, in order to generate a fleet or a vehicle safety report, several general steps should be performed.

More specifically, in one embodiment of the present invention, the method of generating a safety report for a fleet of vehicles comprises: (A) collecting a raw acceleration data for each maneuver for each vehicle by using a firmware in a vehicle-based mobile unit; (B) processing the collected raw acceleration data; and (C) transmitting the collected processed acceleration data to a secure database (124 of FIG. 2A).

If the vehicle is such that left and right turns, as well as loaded and unloaded trips are in different categories (for example, a drum mixer truck), the step (A) of collecting the raw acceleration data for each maneuver for each vehicle further includes the step of collecting the raw acceleration data for each maneuver for each vehicle by using the firmware in the vehicle-based mobile unit; wherein each such maneuver is selected from the group consisting of: {a right turn when the vehicle is loaded; a left turn when the vehicle is loaded; a start when the vehicle is loaded; a stop when the vehicle is loaded; a turn when the vehicle is unloaded; a start when the vehicle is unloaded; and a stop when the vehicle is unloaded}.

If the vehicle is such that left and right turns are in the same category, but loaded and unloaded trips are in different categories (for example, a symmetrically loaded vehicle), the step (A) of collecting the raw acceleration data for each maneuver for each vehicle further includes the step of collecting the raw acceleration data for each maneuver for each vehicle by using the firmware in the vehicle-based mobile unit; wherein each such maneuver is selected from the group consisting of: {a turn when the vehicle is loaded; a start when the vehicle is loaded; a stop when the vehicle is loaded; a turn when the vehicle is unloaded; a start when the vehicle is unloaded; and a stop when the vehicle is unloaded}.

In one embodiment of the present invention, when the left and right, as well as loaded and unloaded trips are not differentiated, the step (A) of collecting the raw acceleration data for each maneuver for each vehicle further includes the step of collecting the raw acceleration data for each maneuver for each vehicle by using the firmware in the vehicle-based mobile unit; wherein each maneuver is selected from the group consisting of: {a turn; a start; and a stop}.

FIG. 7 illustrates how the raw data is collected by measuring a set of acceleration values for different maneuvers under different vehicle conditions in the following categories {start, stop, right turn, left turn loaded vehicle, and unloaded vehicle}. In the most general case, when each such maneuver is selected from the group consisting of: {a right turn when the vehicle is loaded; a left turn when the vehicle is loaded; a start when the vehicle is loaded; a stop when the vehicle is loaded; a turn when the vehicle is unloaded; a start when the vehicle is unloaded; and a stop when the vehicle is unloaded}, the acceleration values are measured for different maneuvers under different vehicle conditions in the following categories {start, stop, right turn, left turn loaded vehicle, and unloaded vehicle}.

Referring still to FIG. 7, after a maneuver has been detected and has been completed, the maximum acceleration value reached in that maneuver is saved for further processing. The vehicle is determined to be loaded between the time the mobile unit detects loading at a home site, and the time that a pour is detected at a job site. The unloaded condition is between the pour and the next loading.

The DriveSafe firmware in the mobile unit also gathers vehicle speed data, as was disclosed above. The speed is sampled once per second and the maximum speed over the past minute is determined. A counter in the speed category corresponding to this maximum speed is incremented.

As with all DriveSafe data, it is assumed that over a broad reporting period of time all drivers will encounter similar jobs and driving conditions, and that an average vehicle speed for all driving will be relevant. The data collection algorithm also corrects for missing data due to short GPS dropouts and errors that may occur during satellite constellation changes. Wireless communication fades do not affect the system, as data are retained and reliably sent when the vehicle returns to a better coverage area.

For each category of data, a set of data “bins” is reserved. Each bin includes a count of the occurrences of an acceleration value in a particular range. After the maximum acceleration for a maneuver has been calculated, the count in the bin in which the acceleration falls is incremented.

DriveSafe also considers the effect of the asymmetrical load on truck stability. In the case of drum mix truck, the mixer drum speed affects the truck stability during right turns. Indeed, because of the dynamics of the concrete in the drum, a higher drum speed makes right turns more prone to safety issues. This is factored into the data by applying a bin weighting factor. More specifically, this is factored into the data by incrementing the bin for a higher acceleration than that actually measured. Above a maximum acceptable drum speed, the measured acceleration is increased proportionally to the excess drum speed, causing the driver's right turn to be recorded as having a higher acceleration.

The counts in the acceleration bins are transmitted to the database when the truck's ignition is turned off. This is done automatically using reliable wireless communications without operator intervention and without any manual data gathering procedures. After transmitting the data to the database, the bin counts are cleared.

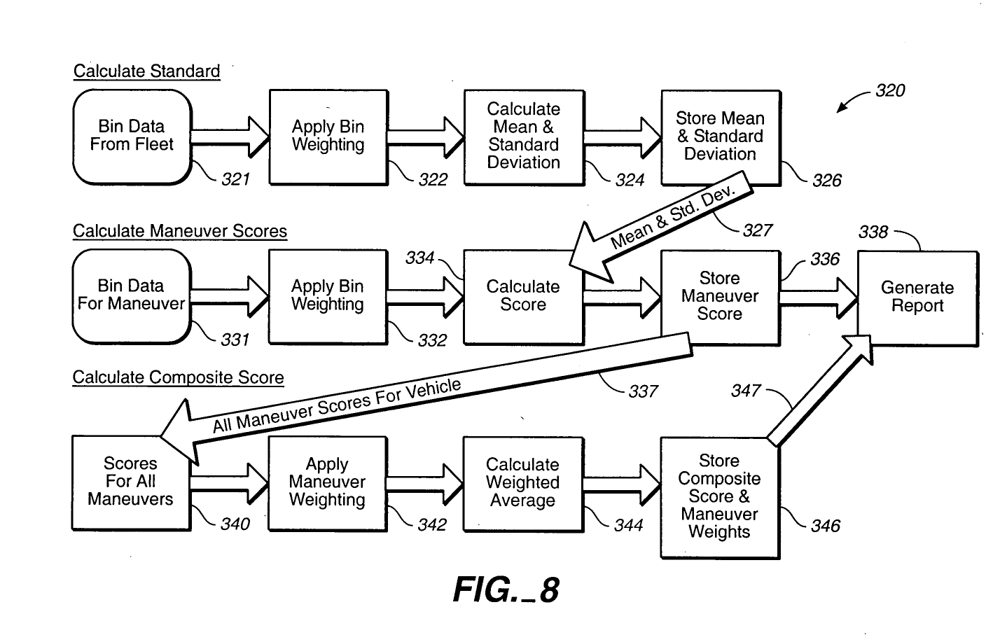

The overall processing of bin data to determine a vehicle score is shown in the flow chart 320 of FIG. 8. The disclosed above bin weighting procedure is applied to the counts in each bin before further processing is done.

To calculate the standards, the acceleration data on a group of vehicles (fleet) (block 321 of FIG. 8) on each maneuver is collected. The acceleration data includes counts of acceleration values falling within certain ranges named bins. Next, the bin weighting procedure 322 is applied for calculating a mean and standard deviation 324 on a maneuver-by-maneuver basis that is used as a standard. The standards are stored in the database (block 326).

Referring still to FIG. 8, to calculate the maneuver scores, at first the bin data on each maneuver are collected (block 331), whereas the count in each bin is multiplied by the acceleration value of the midpoint of the bin range, and the resulting values for all bins are added together. The bin weighting procedure 332 is applied for each bin within a maneuver, whereas for each maneuver, the weighted mean and standard deviation of the acceleration sums for all vehicles in the fleet are calculated with the weights comprising the number of data points used to calculate the bin sum.

To calculate the score for each maneuver, for each vehicle for each maneuver, the bin sum is compared (block 334) to the weighted mean and standard deviation for the fleet that are previously calculated in block 326 and downloaded (arrow 327) from the database.

In one embodiment, the scoring process arbitrarily assumes that the fleet mean is a score of 100 and one standard deviation is a score of 10. The individual vehicle score is then calculated by comparing to the fleet statistics. For example, if the fleet mean is 0.20 and the standard deviation is 0.01, a vehicle with a measured acceleration of 0.22 would have a score of 120, and a measurement of 0.19 would be a score of 90. Other methods for generating the actual score may be envisioned, depending upon the desires of the end user and the statistical distribution of the individual vehicle bin sums within the fleet. For example, the mean score might be defined as zero and the variations from the mean might be positive or negative numbers.

The value in each bin is converted from a count to a weighted acceleration. Once the bins are weighted, the accelerations in all bins for that maneuver type are added together to determine a single average acceleration value for that maneuver type for that vehicle for that time period. The number of data points and the weighting are stored and carried along with the average, for analytical and historical documentation purposes.

The calculated scores for each maneuver are stored in the secure database (block 336) and are available to generate a safety report (block 338).

To calculate the composite score, a weighted average of the individual maneuver scores is taken (block 344), with the weights assigned based on the perceived importance of each maneuver in determining the composite (block 342). The composite scores are stored in the secured database (344) and also are available for the safety report (arrow 347).

In one embodiment, the DriveSafe data is stored in Trimble's Televisant database. The database is hosted in a secure data center for a high level of reliability and data access control. Each customer can see only their own vehicles' data, and access to the DriveSafe portion of the database is controlled on a user-by-user basis within the customer's staff.

The deployment of the DriveSafe system is a simple process. The hardware is installed in the vehicle, Trimble configures the hardware over the air, data are collected for at least two weeks, and the Web reports are run. The reports can be accessed either from a standalone Web site for DriveSafe-only customers, or as a Reporting menu option for Trimble's AutoStatus customers.

The foregoing description of specific embodiments of the present invention has been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of generating a safety report for a fleet of vehicles comprising:
(A) collecting a raw acceleration data for an each maneuver for each said vehicle by using a firmware in a vehicle-based mobile unit, said vehicle-based mobile unit comprising a computer processor, and a navigation system including a navigation receiver;
(B) processing said collected raw acceleration data; and
(C) transmitting said collected processed acceleration data to a database.

2. The method of claim 1, wherein said step (A) further comprises:
(A1) collecting said raw acceleration data for each said maneuver for each said vehicle by using said firmware in said vehicle-based mobile unit; wherein each said maneuver is selected from the group consisting of: {a right turn when said vehicle is loaded; a left turn when said vehicle is loaded; a start when said vehicle is loaded; a stop when said vehicle is loaded; a turn when said vehicle is unloaded; a start when said vehicle is unloaded; and a stop when said vehicle is unloaded}.

3. The method of claim 1, wherein said step (A) further comprises:
(A2) collecting said raw acceleration data for each said maneuver for each said vehicle by using said firmware in said vehicle-based mobile unit; wherein each said maneuver is selected from the group consisting of: {a turn when said vehicle is loaded; a turn when said vehicle is loaded; a start when said vehicle is loaded; a stop when said vehicle is loaded; a turn when said vehicle is unloaded; a start when said vehicle is unloaded; and a stop when said vehicle is unloaded}.

4. The method of claim 1, wherein said step (A) further comprises:
(A3) collecting said raw acceleration data for each said maneuver for each said vehicle by using said firmware in said vehicle-based mobile unit; wherein each said maneuver is selected from the group consisting of: {a turn; a start; and a stop}.

5. The method of claim 1, wherein said step (B) further comprises:
(B1) reserving a set of data “bins” for each said set of acceleration data collected for one said maneuver; wherein each said bin includes a count of the occurrences of an acceleration value in a particular range;
(B2) calculating a maximum raw acceleration value for each said particular range of acceleration values for said one maneuver;
(B3) incrementing a count in the bin in which said calculated maximum acceleration value falls for said one maneuver;
and
(B4) repeating said steps (B1-B3) for each said maneuver.

6. The method of claim 5 further comprising:
(B5) inputting a set of bin data for said fleet of vehicles for each said maneuver;
(B6) applying a bin weighting factor for each said bin data;
(B7) calculating a mean and a standard deviation for each said maneuver for said fleet of vehicles;
and
(B8) storing said set of said mean and said standard deviation values for each said maneuver for said fleet of vehicles.

7. The method of claim 5 further comprising:
(B9) inputting set of bin data for each said maneuver;
(B10) applying a bin weighting factor for each said bin data;
(B11) calculating a score for each said maneuver for each said vehicle by using said mean and said standard deviation calculated for each said maneuver for said fleet of vehicles in said step (B7);
(B12) storing said set of scores for each said maneuver for each said vehicle in said database;
and
(B13) generating a report for each said maneuver for each said vehicle.

8. The method of claim 7 further comprising:
(B14) inputting said set of scores for each said maneuver for each said vehicle;
(B15) applying a maneuver weighting factor;
(B16) calculating a set of weighted composite scores for all said maneuvers for each said vehicle;
(B17) storing said set of weighted composite scores and said set of maneuver weighting factors for each said vehicle in said database;
and
(B18) generating a report including said set of weighted composite scores and said set of maneuver weighting factors for each said vehicle.

9. The method of claim 1, wherein said step (C) further comprises:
(C1) transmitting said report including said set of weighted composite scores and said set of maneuver weighting factors for each said vehicle to a Web site by using a wireless modem.

10. The method of claim 1, wherein said step (C) of transmitting said collected processed acceleration data to said database further comprises:
(C2) transmitting a set of bin data for each said maneuver for each said vehicle to a Web site for further processing and for generating a safety report.

11. An apparatus for generating a safety report for a fleet of vehicles comprising:
(A) at least one means for collecting a raw acceleration data;
(B) a means for processing said collected raw acceleration data;
and
(C) a means for transmitting said collected processed acceleration data to a database.

12. The apparatus of claim 11, wherein each said means (A) further comprises:
(A1) a navigation system configured to collect said raw acceleration data for each maneuver for one said vehicle.

13. The apparatus of claim 11, wherein said means (A) further comprises:
(A2) a firmware configured to collect said raw acceleration data for each said maneuver for one said vehicle, wherein each said maneuver is selected from the group consisting of: {a turn; a start; and a stop}.

14. The apparatus of claim 11, wherein said means (A) further comprises:
(A3) a firmware configured to collect said raw acceleration data for each said maneuver for one said vehicle, wherein each said maneuver is selected from the group consisting of: {a right turn when said vehicle is loaded; a left turn when said vehicle is loaded; a start when said vehicle is loaded; a stop when said vehicle is loaded; a turn when said vehicle is unloaded; a start when said vehicle is unloaded; and a stop when said vehicle is unloaded}.

15. The apparatus of claim 11, wherein said means (B) further comprises:
(B1) a means for reserving a set of data “bins” for each said set of acceleration data collected for one said maneuver for each said vehicle; wherein each said bin includes a count of the occurrences of an acceleration value in a particular range;
(B2) a means for calculating a maximum raw acceleration value for each said particular range of acceleration values for said one maneuver;
and
(B3) a means for incrementing a count in the bin in which said calculated maximum acceleration value falls for one said maneuver.

16. The apparatus of claim 11, wherein said means (B) further comprises:
(B4) a means for inputting a set of bin data for said fleet of vehicles for each said maneuver;
(B5) a means for applying a bin weighting factor for each said bin data;
(B6) a means for calculating a mean and a standard deviation for each said maneuver for said fleet of vehicles;
and
(B7) a means for storing said set of mean and standard deviation values for each said maneuver for each said vehicle in said fleet of vehicles.

17. The apparatus of claim 11, wherein said means (B) further comprises:
(B8) a means for inputting set of bin data for each said maneuver;
(B9) a means for applying a bin weighting factor for each said bin data;
(B10) a means for calculating a score for each said maneuver for each said vehicle;
(B11) a means for storing said set of scores for each said maneuver for each said vehicle in said database;
and
(B12) a means for generating a report for each said maneuver for each said vehicle.

18. The apparatus of claim 11, wherein said means (B) further comprises:
(B13) a means for inputting said set of scores for each said maneuver for each said vehicle;
(B14) a means for applying a maneuver weighting factor;
(B15) a means for calculating a set of weighted composite scores for all said maneuvers for each said vehicle;
(B16) a database configured to store said set of weighted composite scores and said set of maneuver weighting factors for each said vehicle;
and
(B17) a means for generating a report including said set of weighted composite scores and said set of maneuver weighting factors for each said vehicle.

19. The apparatus of claim 11, wherein said means (C) further comprises:
(C1) a means for transmitting said report including said set of weighted composite scores and said set of maneuver weighting factors for each said vehicle to a Website.

20. The apparatus of claim 11, wherein said means (C) further comprises:
(C2) a means for transmitting a set of bin data for each said maneuver for each said vehicle to a Website for further processing and for generating a safety report.
